(19) United States
(12) Patent Application Publication
(10) Pub. No.: US 2001/0021651 A1
(43) Pub. Date: Sep. 13, 2001

(54) Call detail record generation in a telecommunications system

(76) Inventors: Alberto Burgaleta-Salinas, Madrid (ES); Patrik Nilsson, Herzogenrath (DE)

Correspondence Address: BURNS DOANE SWECKER & MATHIS L L P, POST OFFICE BOX 1404, ALEXANDRIA, VA, 22313-1404, US

(21) Appl. No.: 09/802,736

(22) Filed: Mar. 9, 2001

(30) Foreign Application Priority Data
Mar. 10, 2000 (GB) 0005648.1

(51) Int. Cl. H04Q 7/20

(52) U.S. Cl. 455/433; 455/422

(57) ABSTRACT

A method of generating Call Detail Records (CDRs) for a subscriber 2 of a mobile telecommunications network 1. The method comprises transferring a CDR interval parameter from the Home Location Register (HLR) 6 of said telecommunications network 1 to a serving exchange 4, said CDR interval parameter being associated with the subscriber 2 and defining the intervals at which CDRs are to be generated for the subscriber 2 by said exchange 4. Following the setting up of a connection initiated by the subscriber 2, CDRs are generated at said exchange 4 periodically according to said defined interval.

### FIELD OF THE INVENTION

The present invention relates to Call Detail Record generation in a telecommunications system and in particular to Call Detail Record generation for mobile subscribers.

### BACKGROUND TO THE INVENTION

In today's mobile telecommunications networks, the operator of a mobile network is able to maintain tight control over the calls made and services used by its subscribers when they are at home, i.e. when they are registered with the operator's own network. For example, if a subscriber exceeds his calling credit limit the operator can notify the subscriber of this situation and/or can prevent the subscriber from making further calls until his outstanding account is settled. Similarly, where a subscriber makes use of a top-up account, e.g. using scratch cards to credit his account, an operator can restrict the subscriber's access when the subscriber's credit drops to zero.

Such charging control is possible because the Mobile Switching Centre (MSC) which acts as the “local exchange” for a subscriber sends Call Detail Records (CDRs) at regular intervals to a charging node of the subscriber's home network. The frequency at which CDRs are sent is predefined for a given exchange (e.g. every 5 minutes) and is applied to all subscribers registered with that exchange. However, this is only possible when the serving MSC is an MSC of the home network. In the event that a mobile subscriber is registered with an MSC of a foreign network (i.e. the subscriber is “roaming”), CDRs generated by the MSC are passed to a home network through a clearing house in so-called TAP files (if necessary, multiple CDRs are collated in the foreign network and the collated CDRs are sent to the clearing house in a single TAP file). It can take at least two days or even more before the CDRs are forwarded on to the home network.

A home network cannot therefore monitor, in real time or near real time, the charges being incurred by one of its subscribers when that subscriber is roaming in a foreign network. Rather, charging information is only sent periodically from the foreign network to the home network (e.g. every few days). There therefore exists a possibility that fraud by a roaming subscriber will go undetected by the subscriber's home network for some time, and that during that time the home network operator will incur considerable losses. Furthermore, even though CDRs can be generated periodically for a subscriber when that subscriber is registered with his home network, the use of exchanges which generate CDRs at fixed regular intervals for all registered subscribers represents a non-optimal solution as the fixed interval may be too long for certain classes of subscribers and too short for others, and can unnecessarily increase the computational load in the serving exchange.

### SUMMARY OF THE PRESENT INVENTION

It is an object of the present invention to overcome or at least mitigate the above noted disadvantages. In particular, it is an object of the present invention to provide cost and fraud control for all subscribers in real time or close to real time. It is also an object of the present invention to provide for subscriber dependent CDR generation.

According to a first aspect of the present invention there is provided a method of generating Call Detail Records (CDRs) for a subscriber of a mobile telecommunications network, the method comprising:

transferring a CDR interval parameter from a subscriber database of said telecommunications network to a serving exchange, said CDR interval parameter being associated with the subscriber and defining the intervals at which CDRs are to be generated for the subscriber by said exchange; and

following the setting up of a connection initiated by the subscriber, generating CDRs at said exchange periodically according to said defined interval.

Embodiments of the present invention enable different subscribers to be allocated different CDR interval parameters (or none at all). Thus, CDR generation can be optimised on a subscriber by subscriber basis. The unnecessary generation of CDRs by a serving exchange can be reduced or eliminated, thus optimising the load on the exchange and other network nodes. The volume of charging related signalling traffic may also be optimised.

Preferably said subscriber database is a Home Location Register (HLR) of the home network. Alternatively, the database may be located at an MSC or other serving exchange.

It will be appreciated that the exchange with which the subscriber is registered may be an exchange of said telecommunication network (i.e. the subscriber's home network) or of a foreign network. In a GSM network, the exchange may be an MSC/VLR or Gateway MSC (GMSC). In a GPRS network, the exchange may be a SGSN. In other networks of course, other types of exchange may be involved.

Preferably, said step of transferring a CDR interval parameter from the Home Location Register (HLR) of said telecommunications network to said serving exchange is carried out during the registration of the subscriber with the exchange. Alternatively, the step of transferring a CDR interval parameter from the Home Location Register (HLR) of said telecommunications network to said serving exchange may be carried out during a Roaming Interrogation procedure or by way of an administration procedure.

Preferably, the subscriber is identified during the registration process and at the HLR by a unique International Mobile Subscriber Identity (IMSI).

Preferably, CDR interval parameters are transferred between the home network and the foreign network using a traffical protocol. More preferably, in GSM and GPRS networks the traffical protocol is the Mobile Application Part (MAP) protocol.

Preferably, said generated CDRs are sent, during (and after) a connection to a mediation device of said telecommunications network. More preferably, the CDRs are sent using an IP based protocol.

According to second aspect of the present invention there is provided a Home Location Register (HLR) of a telecommunications network, the HLR comprising;

memory means storing an identifier for each subscriber of the network and, associated with each identifier, a Call Detail Record (CDR) interval parameter, a CDR interval parameter defining for the corresponding subscriber the interval at which CDRs should be generated by an exchange with which the subscriber is registered during connections initiated by the subscriber; and

means for transferring the CDR interval parameter associated with a subscriber to an exchange, following receipt by the HLR of a request from that exchange.

Preferably, said request is received during a registration of the subscriber with a serving exchange.

According to a third aspect of the present invention there is provided an exchange of a telecommunications network, the exchange being arranged to receive from one or more Home Location Register (HLRs), CDR interval parameters for respective subscribers registered with the exchange, and, following the establishment of a connection initiated by a subscriber, to generate CDRs at the corresponding defined interval.

### BRIEF DESCRIPTION OF THE DRAWINGS

FIG. 1 illustrates schematically a telecommunications system embodying the present invention; and

FIG. 2 is a flow diagram illustrating a method of controlling charging in the system of FIG. 1.

### DETAILED DESCRIPTION OF CERTAIN EMBODIMENTS

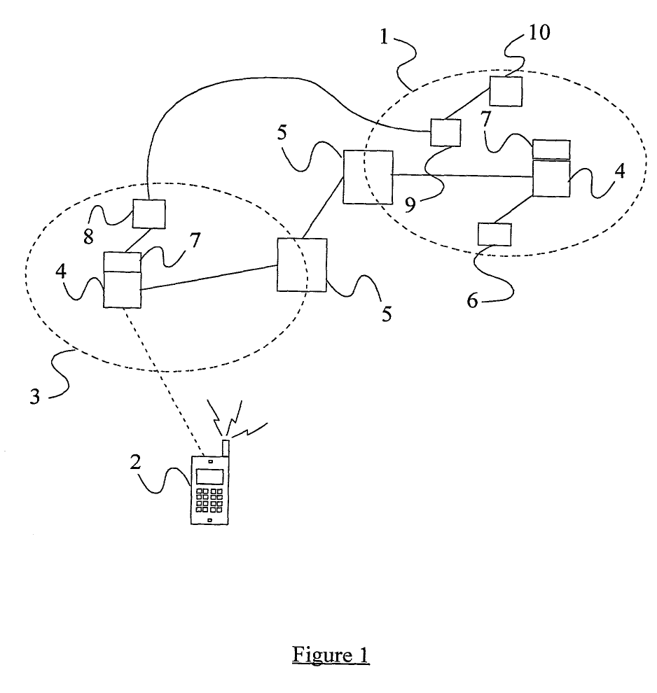

There is illustrated in FIG. 1 a telecommunications system comprising two interconnected Public Land Mobile Networks (PLMNs). For the purposes of the following illustration, a first of the PLMNs 1 represents the home network of a subscriber using a mobile terminal 2, and is referred to as the Home PLMN (HPLMN). The second of the PLMNs 3 is referred to as the Visited PLMN (VPLMN). Both networks are Global System for Mobile communications (GSM) based networks and comprise a number of Mobile Switching Centres (MSCs) 4. The networks 1, 2 are coupled via respective Gateway MSCs (GMSCs) 5. Each network also comprises Base Transceiver Stations (BTSs) and Base Station Controllers (BSCs) which serve as the interface between mobile terminals and MSCs, although these are omitted from FIG. 1.

Both of the networks comprise a Home Location Register (HLR) 6 although this is only illustrated in FIG. 1 for the HPLMN 1. The HLR 6 maintains a record of all of the subscribers of the HPLMN 2, including the International Mobile Subscriber Identity (IMSI) for each subscriber and which is used by a subscriber to register with a network. For each subscriber, the HLR 6 has the option of recording a Call Detail Record (CDR) interval parameter (the parameter being a time, e.g. 5 minutes, 30 minutes, etc). The function of a CDR interval parameter will be described further below.

Associated with each MSC 4 is a Visitor Location Register (VLR) 7 which maintains a record of subscribers currently registered with the associated MSC 4. The record includes subscribers for whom the MSC 4 is a home MSC, as well as subscribers for whom the MSC 4 is a foreign network. In the event that the subscriber using the terminal 2 roams outside of the coverage area of his HPLMN 1 and into the coverage area of the VPLMN 3, his terminal 2 will seek to register with an MSC 4 of the VPLMN 3 after the MSC 4 has determined that the subscriber is a foreign network and has not already been registered in the associated VLR 7.

The registration process is initiated by the terminal 2 sending to the serving MSC 4 the subscriber's IMSI (usually stored in a SIM card). In order to authenticate the subscriber, the MSC 4 uses the Mobile Application Part (MAP) protocol to send a MAP UPDATE_LOCATION message to the HLR 6 of the subscriber's HPLMN 1 (the HPLMN 1 is identified by a prefix part of the IMSI). Assuming that the HLR 6 verifies the IMSI contained in the message, the HLR 6 returns a MAP INSERT_SUBSCRIBER_DATA message to the serving MSC. The returned message also includes the CDR interval parameter (if any) which is recorded by the HLR 6 for the subscriber in question. In the event that the HLR 6 cannot verify the subscriber, an appropriate message is returned to the serving MSC 4.

Assuming now that the serving MSC 4 does indeed receive a MAP UPDATE_SUBSCRIBER_DATA message from the HLR 6 of the HPLMN 1, the subscriber is registered in the VLR 7. Any received CDR interval parameter is also recorded in the VLR 7.

In the event that a subscriber initiates a connection, e.g. a voice call to a subscriber of the same or a different network, the MSC 4 retrieves the CDR interval parameter from the VLR 7. Once the connection is established, the MSC 4 proceeds to generate a CDR after the elapse of each time interval defined by the CDR interval parameter (for additional information on CDRs reference should be made to GSM 12.05 and 12.15). The CDRs are sent by the MSC 4, via a (gateway) mediation device 8 of the foreign network, to a mediation device 9 of the HPLMN 1 over an IP based network. The CDRs may then be transferred to a charging node 10. The CDRs may be used by the HPLMN 1 for the purpose of near real time billing and fraud control.

The CDRs may also be used to control the availability of services to the subscriber. For example, if the HPLMN 1 determines that the subscriber has exceeded his current credit limit, or that the balance of a pre-paid account has reached zero, the HPLMN 1 may decide to terminate the subscriber's connection. This may be achieved by the sending of a MAP CANCEL_LOCATION message (which is an Immediate Service Termination function—see GSM 02.32) from the HPLMN 1 to the serving MSC 4, followed by the sending of MAP 1ST_COMMAND messages to all MSCs holding “activities” for the subscriber. Other MAP messages may also be defined for instructing the serving MSC to take other specific actions as well as for confirming to the HPLMN the action taken by the serving MSC.

Subscribers may be categorised by the HPLMN 1, with the CDR interval parameter being dependent upon the particular category. For example, one category may be pre-paid subscribers (with a CDR interval parameter of say 5 minutes) whilst another category may be business users (with a CDR interval parameter of say 30 minutes). The CDR interval parameter may identify only a subscriber category, whereby the serving MSC 4 which receives the CDR interval parameter determines the require time interval using the CDR interval parameter.

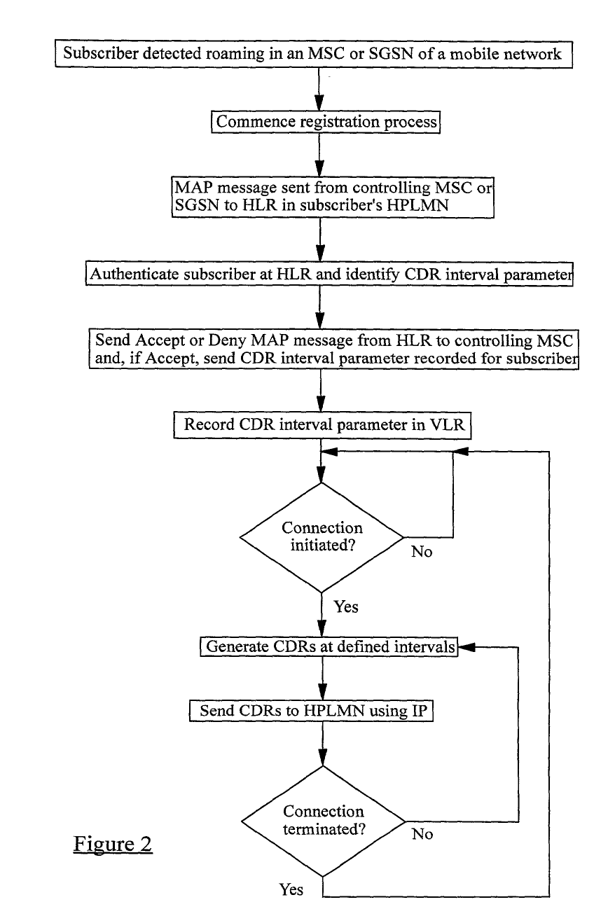

FIG. 2 is a flow diagram further illustrating the method described above.

The above example is concerned with transferring the CDR interval parameter between a HPLMN and a VPLMN during a mobile registration process. However, the parameter may alternatively be transferred between the HLR of the home network and a Gateway MSC (of the home or of a foreign network) during a Roaming Interrogation procedure. Such a procedure arises when an incoming call is received by a GMSC of a mobile network. The GMSC sends a Roaming Interrogation message to the HLR to obtain the location of the called mobile subscriber (i.e. the identity of the MSC to which the subscriber is currently registered). The HLR returns the requested identity in a Roaming Interrogation Ack. message. The HLR may incorporate the CDR interval parameter into the Roaming Interrogation Ack. message for use by the GMSC. CDR interval parameters may also be transferred during administration procedures, for example in an INSERT_SUBSCRIBER_DATA message.

Messages relating to charging events (i.e. CDRs) are sent between the HPLMN 1 and the VPLMN 3 using an IP based protocol. This enables the near real time transfer of charging related information (subject of course to small transmission delays). In this way it is possible to monitor the charging related activities of roaming subscribers in a way which does not greatly increase inter-network signalling traffic.

It will be appreciated by the person of skill in the art that various modifications may be made to the above described embodiment without departing from the scope of the present invention. For example, rather than GSM networks, the invention may be employed in third generation UMTS networks. It will further be appreciated that the terms used above, e.g. MSC, GMSC, etc, may have different equivalents in UMTS. Where the network is a GPRS based network, charging information may be exchanged between Serving GPRS Support Nodes (SGSNs) and Gateway GPRS Support Nodes (GGSNs).

1. A method of generating Call Detail Records (CDRs) for a subscriber of a mobile telecommunications network, the method comprising:
transferring a CDR interval parameter from a subscriber database of said telecommunications network to a serving exchange, said CDR interval parameter being associated with the subscriber and defining the intervals at which CDRs are to be generated for the subscriber by said exchange; and
following the setting up of a connection initiated by the subscriber, generating CDRs at said exchange periodically according to said defined interval.

2. A method according to claim 1, wherein the exchange with which the subscriber is registered is an exchange of said telecommunication network or of a foreign network.

3. A method according to claim 1, wherein said network is a GSM network and the exchange is an MSC/VLR.

4. A method according to claim 1, wherein said network is a GSM/GPRS network and the exchange is a SGSN.

5. A method according to claim 1, wherein said subscriber database is a Home Location Register (HLR).

6. A method according to claim 1, wherein said step of transferring a CDR interval parameter from the Home Location Register (HLR) of said telecommunications network to said serving exchange is carried out during the registration of the subscriber with the exchange.

7. A method according to claim 1, wherein said CDR interval parameter is transferred between the home network and the foreign network using a traffical protocol.

8. A method according to claim 7, wherein said traffical protocol is the Mobile Application Part (MAP) protocol.

9. A method according to claim 1, wherein said CDRs are sent during a connection, to a mediation node of said telecommunications network using an IP based protocol.

10. A Home Location Register (HLR) of a telecommunications network, the HLR comprising;
memory means storing an identifier for each subscriber of the network and, associated with each identifier, a Call Detail Record (CDR) interval parameter, a CDR interval parameter defining for the corresponding subscriber the interval at which CDRs should be generated by an exchange with which the subscriber is registered during connections initiated by the subscriber; and
means for transferring the CDR interval parameter associated with a subscriber to an exchange, following receipt by the HLR of a request from that exchange.

11. A HLR according to claim 10, wherein said request is received during a registration of the subscriber with a serving exchange.

12. An exchange of a telecommunications network, the exchange being arranged to receive from one or more Home Location Register (HLRs) CDR interval parameters for respective subscribers registered with the exchange, and, following the establishment of a connection initiated by a subscriber, to generate CDRs at the corresponding defined interval.
